(19) United States
(12) Patent Application Publication
(10) Pub. No.: US 2006/0114205 A1
(43) Pub. Date: Jun. 1, 2006

(54) Driving system of a display panel

(75) Inventors: Yuh-Ren Shen, Tainan (TW); Cheng-Jung Chen, Hsien (TW)

Correspondence Address: DENNISON, SCHULTZ, DOUGHERTY;& MACDONALD, SUITE 105, 1727 KING STREET, ALEXANDRIA, VA, 22314-2700, US

(73) Assignee: VastView Technology Inc.

(21) Appl. No.: 10/989,264

(22) Filed: Nov. 17, 2004

(51) Int. Cl. G09G 3/36

(52) U.S. Cl. 345/88

(57) ABSTRACT

A driving system of a display panel includes a timing control module with a timing controller for receiving image data, a Gamma circuit, a source driving circuit module and a gate driving circuit module; wherein the Gamma circuit generates at least two Gamma voltages for the image data and outputs to the source driving circuit module. The timing controller includes a three-Gamma lookup table for improving the bit numbers of the image data and outputting to the source driving circuit module by way of using virtual bit technique, and outputting control signals to the source driving circuit module or gate driving circuit module for providing colors displayed on the display panel. The source driving circuit module further includes a digital-to-analog converter for translating signals. The driving system of the present invention suits for various types display panel.

### BACKGROUND OF THE INVENTION

1. Field of the Invention

The present invention relates to a driving system of a display panel and, more particularly, relates to a driving system of a display panel, which has a timing controller with a three-Gamma lookup table for regulating the input and output relation of RGB image data, and provides a source driver with a digital-to-analog converter for translating image gray codes into corresponding data voltages to present gray levels by way of using linear or segment linear method, the Gamma circuit only needs to provide at least two Gamma voltages so as to effectively reduce the system resource and improve the color display performance, furthermore, the driving system suits for various types display panel.

2. Description of the Related Art

Accompanying the science and technology progressing and suitable material developing, the display systems in optical-electrical field being developed toward to light-weight and thin-shaped, such as the Liquid Crystal Display (LCD), Plasma Display Panel (PDP), Organic Light Emitting Display (OLED), etc, have formed the mainstream of the display industry. The relative manufactures do their best to improve the display performance of the display panel for providing the products to satisfy the users.

Please refer to FIG. 1 to FIG. 4, traditional driving system 90 of a display panel comprises a timing control module 91, a source driving circuit module 92 and a gate driving circuit module 93, wherein the timing control module 91 has a timing controller 911 and a Gamma circuit 912. The source driving circuit module 92 has a plurality of source driving circuits 921, and the gate driving circuit module 93 has a plurality of gate driving circuits 931. The source driving circuits 921 and gate driving circuits 931 are placed on the top side and left side of the display panel 94, respectively. The source driving circuits 921 and gate driving circuits 931 also control the data lines and gate lines of the display panel 94 respectively for providing image signals. The timing controller 911 receives the RGB image data in the TTL (Transistor-Transistor Logic) or LVDS (Low Voltage Differential Signaling) form, and outputs the RGB image data in the TTL or RSDS (Reduced Swing Differential Signaling) form. At the same time, the timing controller 911 outputs the control signals (including STV, POL, DCLK, STH, OEN, CLK, etc) to the source driving circuits 921 of the source driving circuit module 92 or the gate driving circuits 931 of the gate driving circuit module 93, wherein, the data output normal are 6 or 8 bits. The source driving circuits 921 has an interface with TTL or RSDS format for the purpose of receiving the RGB image data, and receives the control signals (including STV, POL, DCLK, STH, OEN, CLK, etc). Similarly, the gate driving circuits 931 has an interface with TTL format for the purpose of receiving the RGB image data, and receives the control signals (including STH, OEN, CLK, etc).

The image data consist of RGB colors. Every color uses gray level to present its deep or light and every gray level corresponds to a gray code according to the total gray levels. Using 8 bits as an example, the total gray levels are 2⁸=256, and every gray level from black to white is presented by 0-255 gray code. As shown in FIG. 3, due to there exists a non-linear T-V curve 95 between the transmittance (T) of the Liquid Crystal itself and the external voltage (V), if we want to present the linear gray level, we must find out the corresponding voltage of every gray level according to the T-V curve 95 relation. Furthermore, due to the vision response of human's eyes also has non-linear relation with bright gray level. In general, the non-linear relation is approximately to the Gamma value square relation of gray code. Therefore, if we want to present the gray level conformed to human's eyes, the inputting gray code must be translated into corresponding data voltage according to the T-V curve 95 of the Liquid Crystal and default Gamma value and outputted to every pixel on the display panel to present the correct bright.

Considering about the panel structure at present, the translating between the gray code and data voltage is executed by a Gamma circuit 912 according to the T-V curve 95 and default Gamma value and generates a total of 18 Gamma voltages G₁˜G₁₈, wherein G₁˜G₉ are negative Gamma voltages and the G₁₀˜G₁₈ are positive Gamma voltages. The 18 Gamma voltages G₁˜G₁₈ are transferred to the digital-to-analog converter (DAC) of the source driver, and uses the 18 Gamma voltages G₁˜G₁₈ as reference voltage, and translates the gray codes into corresponding voltages by way of using a nonlinear-period resistor network of the DAC. As an example in FIG. 3, the G₁˜G₉ with negative Gamma voltages are corresponding to 9 reference voltages between gray code 255˜0, if the gray code between 223˜255, the corresponding voltage according to the reference voltage of G₁ and G₂ uses nonlinear-period resistor network of the DAC interposing its corresponding data voltage.

The aforesaid traditional display panel has the following drawbacks: 1. The nonlinear-period resistor network of the DAC is designed according to the reference voltage outputted by the Gamma circuit and T-V curve 95 of the Liquid Crystal, the resistor network can not be adjusted after design, therefore, the display panel with different Gamma circuit or display characteristic can not be adjusted flexibly the presenting color characteristic; 2. As shown in FIG. 4, the color shift of the display panel, due to the Liquid Crystal will generate various phase retardations (δ=Δn×d/λ) corresponding to various color lights, thus makes the T-V curve of the RGB color lights different, therefore, in more bright region (such as A region) will generate color shift due to the phase retardations, while in more dark region (such as B region) will generate leakage so as to make the color displayed on the panel distorting, however, if the traditional structure wants to further modify the color shift between every color, the Gamma circuit must output 3 sets Gamma voltages (totally 3×18=54) respectively, such that it will increase the complexity of driving circuit and cost, even will decrease the yield rate, so it is not practically; 3. Due to the data voltage translating is executed by way of using interposing method according to the nonlinear-period resistor network of the DAC, when the curve is vibrated sharply, the present colors translated by the nonlinear-period resistor network of the DAC are not perfectly and limited by the design of the nonlinear-period resistor network of the DAC, therefore, the distribution rate of Gamma circuit voltage can not be adjusted so as to limit the color adjusting.

According to the aforesaid description, there needs a novel driving system of a display panel that can solve the aforesaid drawbacks of the traditional structure, and make the display panel with perfect color display effect.

### SUMMARY OF THE INVENTION

The present invention has been accomplished under the circumstances in view. It is therefore the main object of the present invention to provide a driving system of the display panel, which eliminates the aforesaid drawbacks.

According to one aspect of the present invention, the object of the present invention is to provide a driving system of the display panel, which comprises a timing controller with a three- Gamma lookup table for improving the bit numbers of the image data and adjusting the corresponding relation of the input and output image data by way of using virtual bit technique, so as to solve the color shift of RGB and make the gray levels be presented more flexibly.

According to one aspect of the present invention, another object of the present invention is to provide a driving system of a display panel with simplifying to at least two Gamma voltages output and high accuracy, so as to reduce the manufacturing cost and improve the product competition.

To overcome the drawbacks of the aforesaid prior art, the driving system of a display panel of the present invention comprises: a timing control module, a source driving circuit module with a plurality of source drivers and a gate driving circuit module with a plurality of gate drivers, wherein the timing control module having a timing controller for receiving input gray-scale data, and improving image bits of said image data by using virtual bit technique; the virtual bit technique comprises using frame rate control (FRC) or dithering technique to improve the total bits of input image gray level; the virtual bit technique executed by the timing controller can improve the 6, 8, 10 bits or the input gray image with total gray levels between 64 to 1024 to 6+2,8+2,10+2 bits or image gray signals with total gray levels between 64 to 4056.

The timing controller further comprises a three-Gamma lookup table for improving the bit numbers of the image data and outputting to the source driving circuit module by way of using virtual bit technique, and outputting control signals to the source driving circuit module or gate driving circuit module for providing colors displaying on the display panel. The three Gamma value lookup table of the timing controller stores translating relations of green, red and blue color respectively according to a T-V curve and default Gamma value of the Liquid Crystal, and translates gray code of the input green, red and blue color into the modification gray code conformed with the T-V curve and default Gamma value of the Liquid Crystal by way of using the lookup table, respectively. The driving system of the display panel also comprises a Gamma circuit for generating at least two Gamma voltages and outputting to the source driving circuit module as a reference voltage.

The source driving circuit module also comprises a digital-to-analog converter for receiving the Gamma voltage generated by the timing control module, and using the Gamma voltage as a reference voltage as well as translating the modification gray code in digital form into data voltage in analog form for driving the Liquid Crystal, the digital-to-analog converter is a linear digital-to-analog converter or ramp digital-to-analog converter, which can translate the modification gray code into corresponding data voltage according to the received modification gray code and Gamma voltage by way of using linear or segment linear method. The gate driving circuit module receives the control signals from the timing control module for controlling and opening gate lines of the display panel in sequence. The source driving circuit module receives signals from the timing control module for providing colors displayed on the display panel, which comprises a digital-to-analog converter for translating digital signal into analog signal, wherein the digital-to-analog converter is a linear digital-to-analog converter or ramp digital-to-analog converter, which can translate the modification gray code into corresponding data voltage according to the received modification gray code and Gamma voltage by way of using linear or segment linear method. The source driving circuit module receives signals from the timing control module for providing colors displayed on the display panel.

These and other features, aspects, and advantages of the present invention will become apparent by a review of the following detailed description of the preferred embodiment of the invention and by reference to the following drawings.

### BRIEF DESCRIPTION OF THE DRAWINGS

FIG. 1 illustrates a diagram of a traditional display panel structure;

FIG. 2 illustrates a traditional Gamma circuit that can output 18 Gamma voltages;

FIG. 3 illustrates a T-V curve between the transmittance (T) of the Liquid Crystal itself and the external voltage (V), wherein the digital-to-analog converter (DAC) displays the gray code 0˜255 according to the relation between the 18 Gamma voltages and T-V curve;

FIG. 4 illustrates the corresponding curve of the voltage (or gray code) of RGB and the transmittance (T);

FIG. 5A illustrates the driving system of a display panel according to one preferred embodiment of the present invention;

FIG. 5B illustrates the driving system of a display panel according to another preferred embodiment of the present invention;

FIG. 6 illustrates a three-Gamma value lookup table according to one preferred embodiment of the present invention; it explains the corresponding relation between the input gray code and output non-linear modification gray code;

FIG. 7A illustrates a T-V curve of the driving system according to one preferred embodiment of the present invention;

FIG. 7B illustrates a Gamma curve of the driving system according to one preferred embodiment of the present invention;

FIG. 8A illustrates a Gamma circuit that can output 4 linear period Gamma voltages according to one preferred embodiment of the present invention;

FIG. 8B illustrates a Gamma circuit that can output 6 linear period Gamma voltages according to one preferred embodiment of the present invention;

FIG. 8C illustrates a Gamma circuit of the driving system according to one preferred embodiment of the present invention, wherein it further comprises a variable resistor for controlling the Gamma voltage outputting;

FIG. 8D illustrates a Gamma circuit of the driving system according to one preferred embodiment of the present invention, wherein it further comprises a FET for controlling the Gamma voltage outputting;

FIG. 9 illustrates a source driver of the driving system according to one preferred embodiment of the present invention;

FIG. 10A illustrates a linear ramp-DAC of the source driver of the driving system according to one preferred embodiment of the present invention; and

FIG. 10B illustrates a linear DAC of the source driver of the driving system according to one preferred embodiment of the present invention.

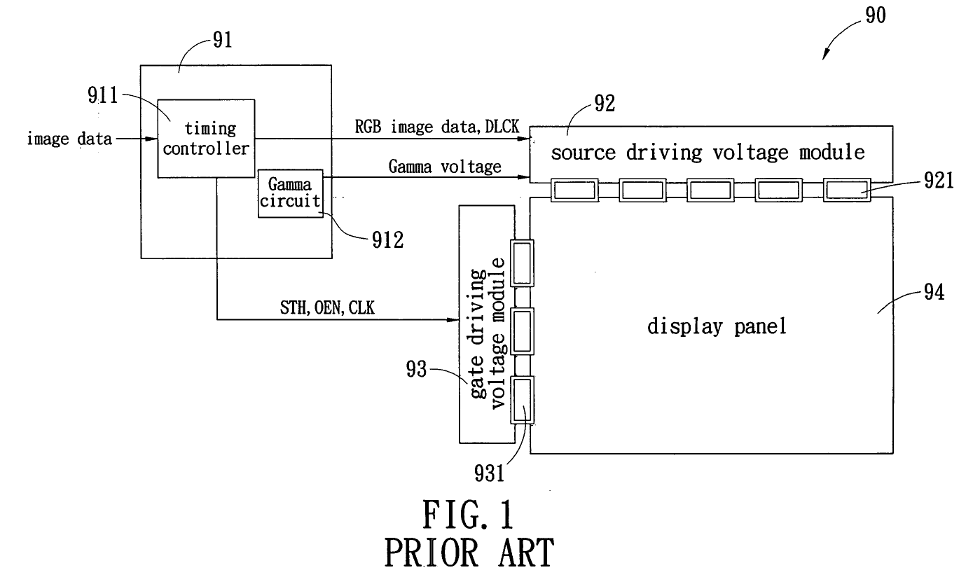

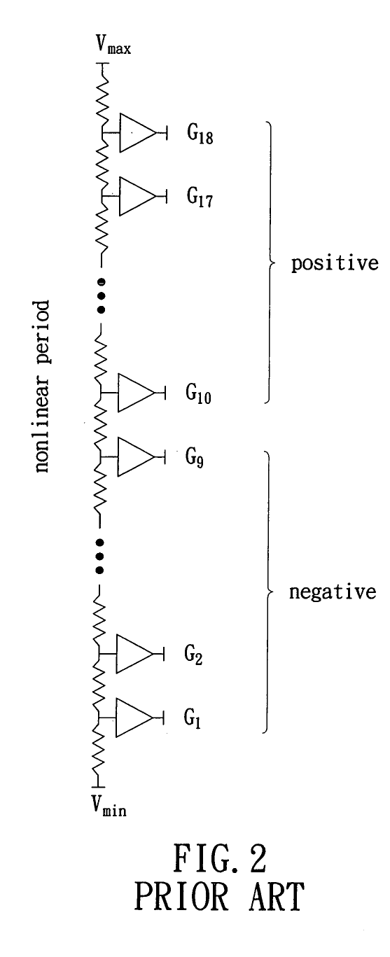

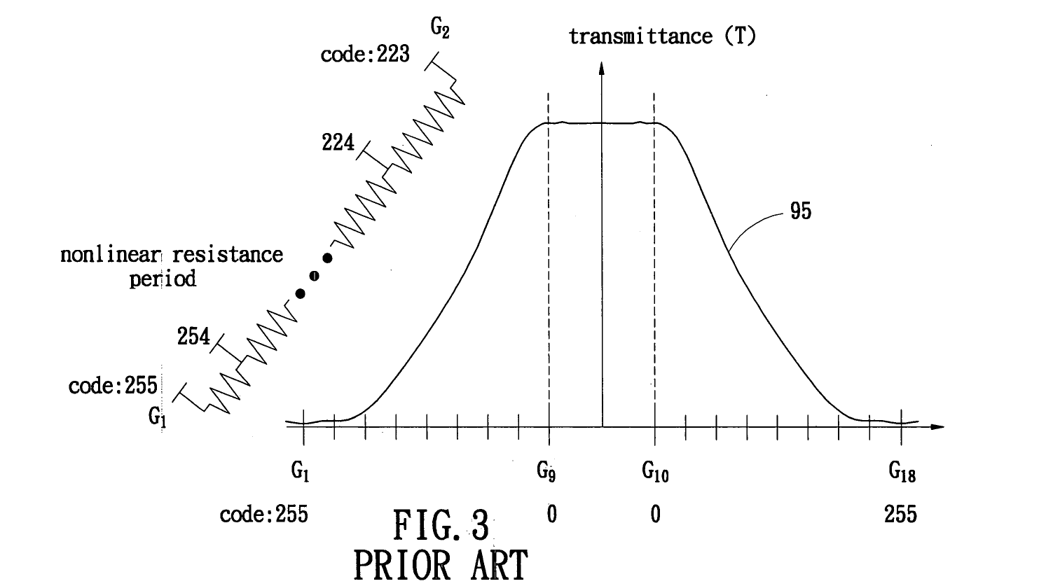

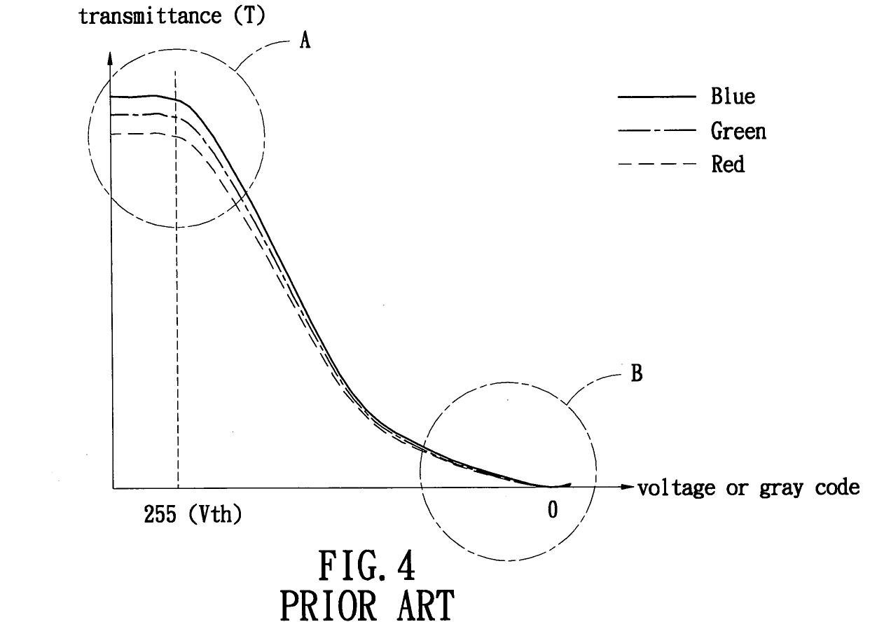

### DETAILED DESCRIPTION OF THE PREFERRED EMBODIMENT

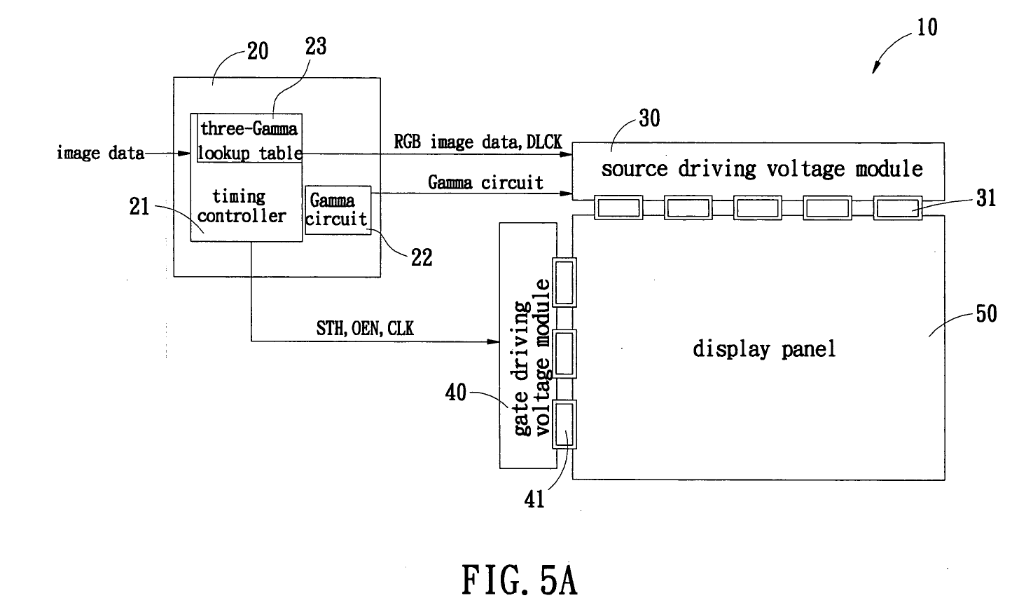

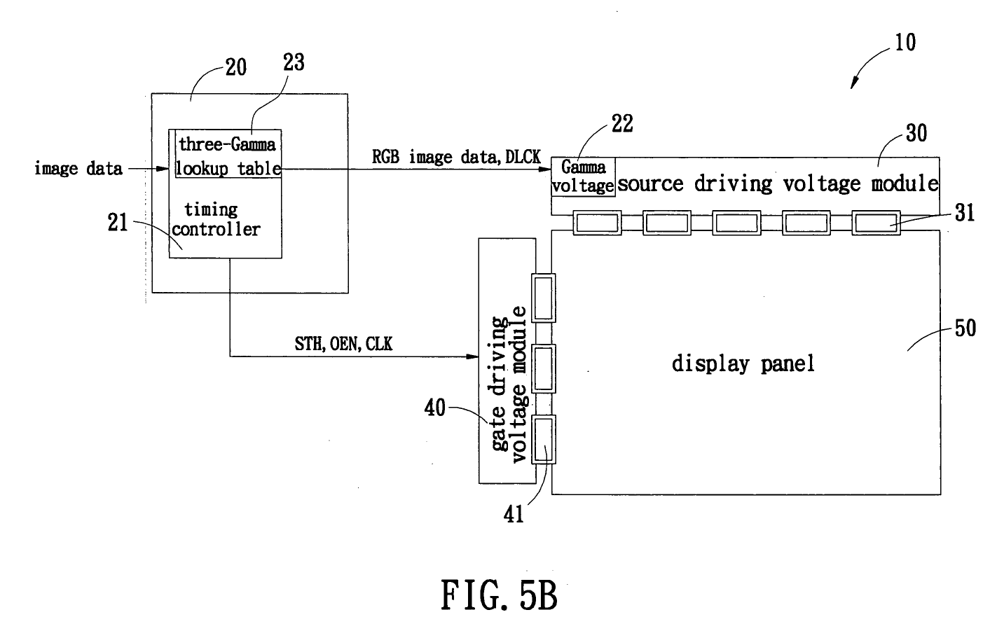

Referring to FIG. 5A˜10B, the driving system 10 according to one preferred embodiment of the present invention comprises a timing control module 20, a source driving circuit module 30 and a gate driving circuit module 40; wherein the timing control module 20 comprises a timing controller 21 and a Gamma circuit 22, the Gamma circuit 22 is provided for translating digital encode signal into corresponding Liquid Crystal driving voltage, generating at least two Gamma voltages and outputting to the source driving circuit module 30 as a reference voltage. The Gamma circuit 22 transmits the Gamma voltage to the source driving circuit module 30 according to the T-V curve 95 of Liquid Crystal. The source driving circuit module 30 comprises a plurality of source drivers 31 and the gate driving circuit module 40 comprises a plurality of gate drivers 41. The source drivers 31 and gate drivers 41 are placed on the top side and left side of the display panel 50 respectively for controlling the data lines and gate lines of the display panel 50 respectively for providing image data. The timing controller 21 can receive image data in a TTL or LVDS form (In general, the image data has 6,8 or 10 bits) and output the RGB image data in the TTL or RSDS (Reduced Swing Differential Signaling) form. At the same time, the timing controller 21 outputs the control signals (including STV, POL, DCLK, STH, OEN, CLK, etc) to the source driving circuits 31 or the gate driving circuits 41. The source driving circuits 31 has an interface with TTL or RSDS format for the purpose of receiving the RGB image data, and receives the control signals (including STV, POL, DCLK, STH, OEN, CLK, etc). Similarly, the gate driving circuits 41 has an interface with TTL format for the purpose of receiving the RGB image data, and receives the control signals (including STH, OEN, CLK, etc). However, the transmission interface for transmitting RGB image data connected between the timing controller 21 and source driving circuit module 30 is not limited to the TTL or RSDS interface, it also can be a LVDS, MINI-LVDS or DVI form image data. Any person who skilled in the art can arbitrarily adjust the combination and the enhancements may be made without departing from the spirit and scope of the invention.

Please refer to FIG. 5B, illustrates the driving system of a display panel according to another preferred embodiment of the present invention. The Gamma circuit 22 of the driving system 10 also can be placed inside the source driving circuit module 30. The Gamma circuit 22 transmits the Gamma voltage to the source driver 31 of the source driving circuit module 30 to achieve the object of the present invention.

The timing controller 21 comprises a three-Gamma lookup table 23. The three-Gamma lookup table 23 stores the translating relations between the input RGB gray code and output RGB gray code respectively. The translating relations are determined according to a T-V curve 95 and default Gamma value of the Liquid Crystal color. Therefore, the input linear RGB gray code will be translated into modification gray code conformed to the T-V curve 95 and default Gamma value of the Liquid Crystal by way of using the three-Gamma lookup table 23. In order to avoid distorting due to translating, it can use virtual bit technique to improve the bit number of the image data so as to describe the translating relation between the linear and nonlinear completely. Using an image data with 8 bits as an example, the input RGB image data has 0˜255 gray level respectively. Using the frame rate control (FRC) or dithering virtual bit technique can improve the total bits of input image data to 10 bits, therefore, the original 256 gray levels can be increased to 1024 gray levels, so as to present the translating relation between the linear and nonlinear gray level completely.

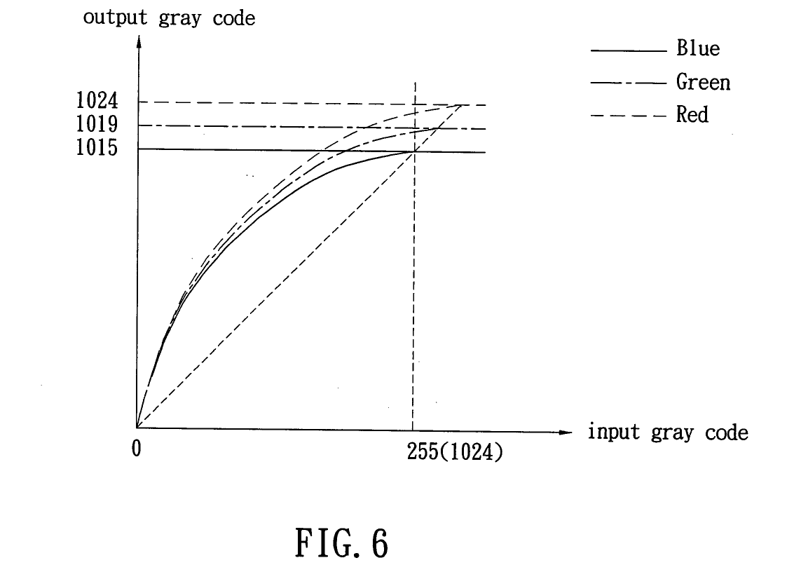

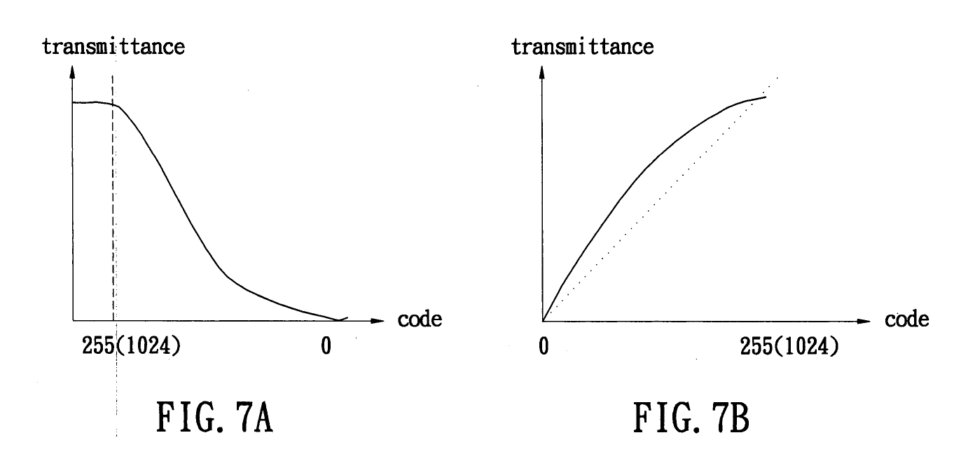

As shown in FIG. 6, the three-Gamma lookup table 23 stores the translating relations between the input RGB gray code and output RGB gray code respectively according to the T-V curve 95 and default Gamma value of the Liquid Crystal and translates the gray code of the input green, red and blue color into the modification gray code conformed to the T-V curve 95 and default Gamma value of the Liquid Crystal by way of using the three-Gamma lookup table 23 respectively. Due to the three-Gamma lookup table 23 stores the gray level translating code of the input RGB colors respectively, therefore, it can translate the RGB gray level code independently. As shown in FIG. 7A or 7B, after the RGB gray level code being translated through the three-Gamma lookup table 23 respectively, it can compensate the color shift phenomenon of the traditional RGB display panel, such that the color presented on the display panel can be presented even better. Similarly, if the input image data with 6 or 10 bits length, the total bits of input image data can be improved from 6 or 10 bits to 8 or 12 bits after using the frame rate control (FRC) or dithering virtual bit technique, therefore, it can get the same effect by way of using the three-Gamma lookup table 23 translation.

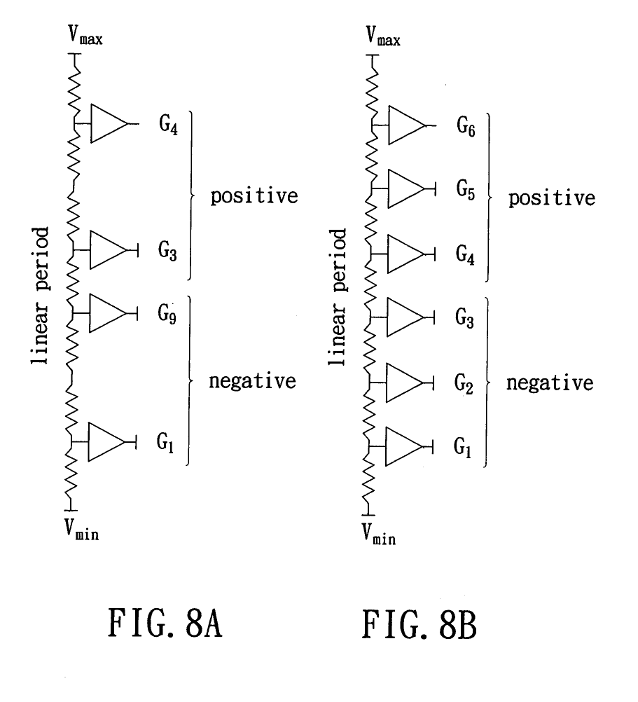

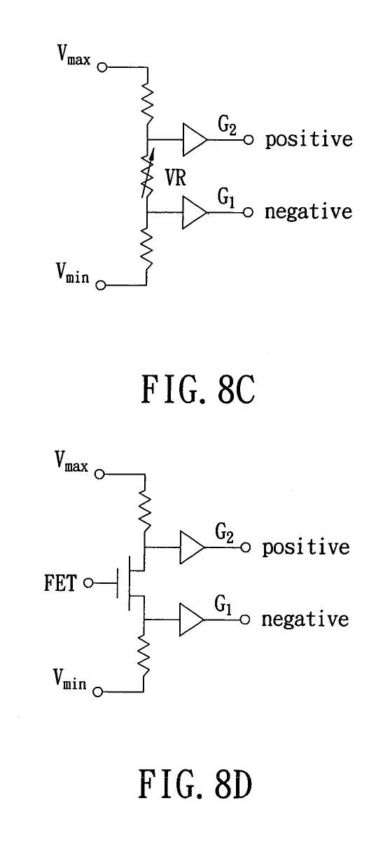

Due to the input gray code has been translated into nonlinear modification gray code through the three-Gamma lookup table 23, so the Gamma circuit 22 needs not to generate 18 sets Gamma voltages as reference voltage anymore. Please refer to FIG. 8A˜8D, the first embodiment of the Gamma circuit 22 sets four Gamma voltages output, wherein G₁ and G₂ are negative, G₃and G₄ are positive. The four Gamma voltages correspond to the gray level of the end of the pure-white and pure-black respectively according to the T-V curve 95 and default Gamma value of the Liquid Crystal. It also can interpose a Gamma voltage between two Gamma voltages as a reference point. The interposed Gamma voltage corresponds to the pure-white and pure-black ends gray level and any reference gray level between them respectively.

Please refer to FIG. 8B, the second embodiment of the Gamma circuit 22 interposes a reference gray level between the end gray level of the positive and negative respectively to form a series Gamma voltage units (G₁ to G₆) with linear periods output, wherein G₁ to G₃ are negative, G₄to G₆ are positive. Similarly, the number of output Gamma voltage can be increased as requirement, and the third embodiment of the Gamma circuit 22 shown in FIG. 8C also can comprise a various resistor (VR) for outputting two Gamma voltages G₁ and G₂ and regulating the voltage of positive and negative by way of using central voltage symmetrical method. The fourth embodiment of the Gamma circuit 22 shown in FIG. 8D has a bipolar driving with single voltage modulating and uses a FET (field effect transistor, FET) replacing the various resistor (VR) to control the outputting Gamma voltages G₁ and G₂. To sum up, the Gamma circuit 22 requires at least two Gamma voltages for providing to the source driving circuit module 30 as reference voltages.

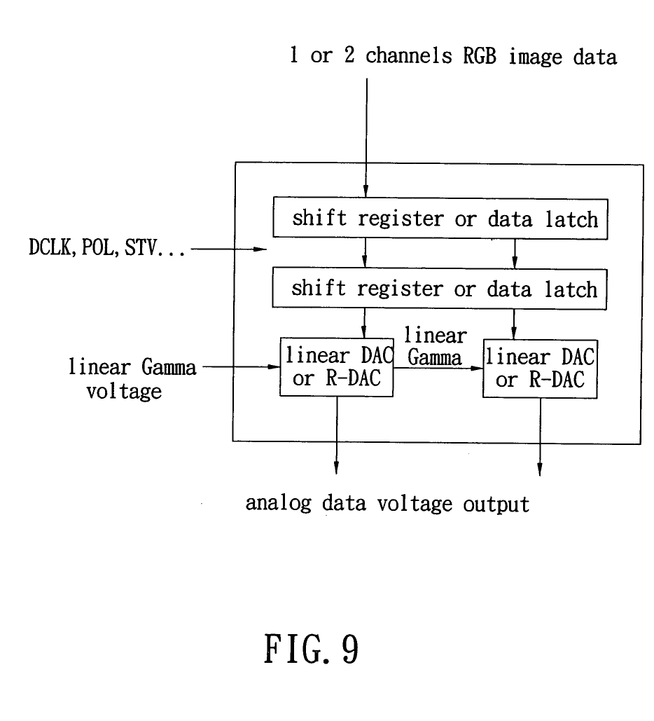

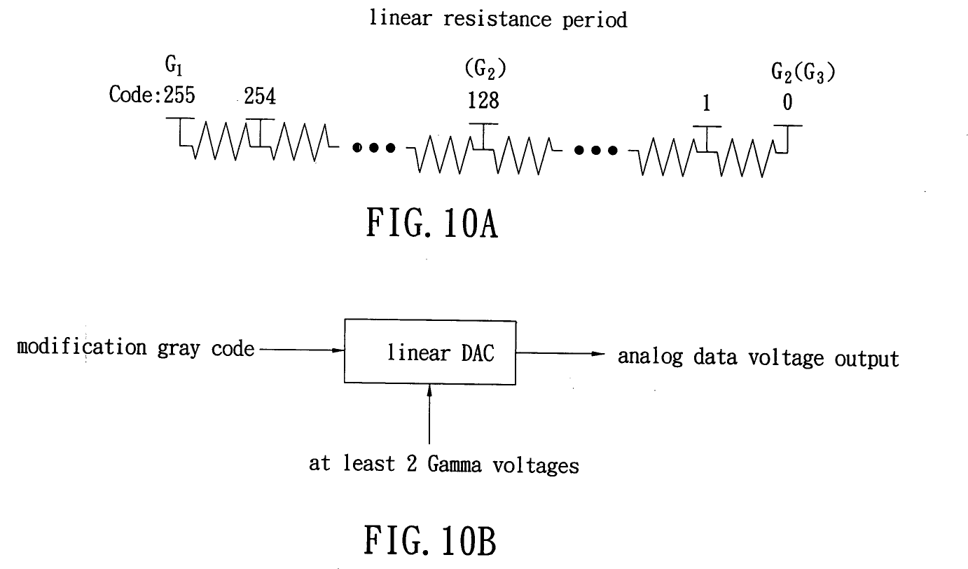

Please refer to FIGS. 9, 10A and 10B, the Gamma voltage, RGB nonlinear modification gray code after adjusting and control signals (STV, POL, DCLK . . . ) can be outputted to the source driver 31. After processing by the shift register or data latch of the source driver 31, the DAC translates the modification gray code into data voltage. Due to the input gray code having been translated into nonlinear gray code according to the T-V curve 95 and default Gamma value of the Liquid Crystal, the DAC does not require complex nonlinear resistor network, instead just requires distributed linear resistor to calculate the data voltage corresponding to the reference voltage provided by the Gamma circuit 22 by way of using the linear interposing method. Therefore, the driving system of the present invention can not only reduce the number of reference voltage provided by the Gamma circuit 22, but also simplify the complex nonlinear resistor network of the traditional DAC. In fact, the design of the internal resistor of DAC is not limited to linear distribution. Certainly, it also can use ramp-DAC, segment linear resistor distribution or even the nonlinear resistor network. The main reason is that the image gray code has been translated into nonlinear modification gray code through three-Gamma lookup table 23. So the Gamma circuit 23 and the internal resistor of DAC can be simplified.

Although particular embodiments of the invention have been described in detail for purposes of illustration, various modifications and enhancements may be made without departing from the spirit and scope of the invention. Accordingly, the invention is not to be limited except as by the appended claims.

Therefore, the driving system of a display panel of the present invention has the following advantages: 1, The driving system of a display panel of the present invention solves the color shift problem, especially, the DAC of source driver presents gray level by linear or segment linear method, so as to let the color present on the display panel more close to the real color of the image data, it also improves the performance of the display panel; 2, The driving system of the present invention just needs to output at least two or more than two Gamma voltages when the DAC structure of the source driver is fix and the DAC can output analog data voltage. At the same time, the DAC just needs linear resistor distribution, thus greatly simplifies the complex internal resistor network of the traditional DAC, also reduces the manufacturing cost so as to achieve the object of saving power, furthermore, the DAC also can be used in display panel with various size or manufactured by various manufactories; 3, Corresponding to the traditional structure of the driving system of a display panel, the driving system of a display panel of the present invention provides fix RGB image data. The RGB image data had been digitized, therefore, the optical processing sequence is not limited, so as to increase the application flexibility and convenience.

What is claimed is:

1. A driving system of a display panel, which comprises a timing control module, a source driving circuit module with a plurality of source drivers and a gate driving circuit module with a plurality of gate drivers, wherein:
said timing control module having a timing controller for receiving input gray-scale data, and improving image bits of said image data by using virtual bit technique; said timing controller further comprising a three-Gamma value lookup table, for translating said input gray-scale data into modification gray code by way of using said lookup table, and outputting said modification gray code with image control signals to said source driving circuit module or gate driving circuit module;
said driving system of said display panel comprising a Gamma circuit, for generating at least two Gamma voltages and outputting to said source driving circuit module as a reference voltage;
said source driving circuit module also comprising a digital-to-analog converter for receiving said Gamma voltage generated by said timing control module, and using said Gamma voltage as a reference voltage as well as translating said modification gray code in digital form into data voltage in analog form for driving a Liquid Crystal; and
said gate driving circuit module receiving said control signals from said timing control module for controlling and opening gate lines of said display panel in sequence.

2. The driving system of a display panel as claimed in claim 1, wherein said virtual bit technique executed by said timing controller comprises using frame rate control (FRC) or dithering technique to improve the total bits of said input image gray level.

3. The driving system of a display panel as claimed in claim 1, wherein said virtual bit technique executed by said timing controller can improve the 6, 8, 10 bits or said input gray image with total gray levels between 64˜1024 to 6+2,8+2,10+2 bits or image gray signals with total gray levels between 64˜4056.

4. The driving system of a display panel as claimed in claim 1, wherein said three Gamma value lookup table of said timing controller stores translating relations of green, red and blue color respectively according to a T-V curve and default Gamma value of said Liquid Crystal, and translates gray code of said input green, red and blue color into said modification gray code conformed with said T-V curve and default Gamma value of said Liquid Crystal by way of using said lookup table respectively.

5. The driving system of a display panel as claimed in claim 1, wherein said Gamma circuit outputs at least two Gamma voltages, and said Gamma voltages corresponds to a pure-white and pure-black end gray level according to said T-V curve and default Gamma value of said Liquid Crystal, respectively.

6. The driving system of a display panel as claimed in claim 1, wherein said Gamma circuit can output more than two Gamma voltages; and said Gamma voltages correspond to said pure-white and pure-black end gray level and any reference gray level between them according to said T-V curve and default Gamma value of said Liquid Crystal, respectively.

7. The driving system of a display panel as claimed in claim 1, wherein said digital-to-analog converter is a linear digital-to-analog converter or ramp digital-to-analog converter, which can translate said modification gray code into corresponding data voltage according to said received modification gray code and Gamma voltage by way of using linear or segment linear method.

8. The driving system of a display panel as claimed in claim 1, wherein said source driving circuit module comprises shift registers or data latch for receiving and processing said modification gray code and image control signals received from said timing control module.

9. The driving system of a display panel as claimed in claim 1, wherein said transmission interface for transmitting RGB image data connected between said timing control module and said source driving circuit module can be a TTL, LVDS, MINI-LVDS or DVI form image data.

10. The driving system of a display panel as claimed in claim 1, wherein said Gamma circuit is placed inside said timing control module.

11. The driving system of a display panel as claimed in claim 1, wherein said Gamma circuit is placed inside said source driving circuit module.
